(19) United States
(12) Patent Application Publication
(10) Pub. No.: US 2017/0289269 A1
(43) Pub. Date: Oct. 5, 2017

(54) DELEGATING A REVERSE PROXY SESSION TO ITS INSTANTIATING PORTLET SESSION

(71) Applicant: CA, Inc., New York, NY (US)

(72) Inventor: Mark BELL, Fort Collins, CO (US)

(73) Assignee: CA, Inc.

(21) Appl. No.: 15/084,156

(22) Filed: Mar. 29, 2016

(51) Int. Cl. H04L 29/08; H04L 29/06; H04L 12/46

(52) U.S. Cl. CPC H04L 67/142; H04L 12/4633; H04L 67/28; H04L 63/08

(57) ABSTRACT

A method for allowing a web application server to encapsulate the features and functionality of an external application while gating access to it through authenticated portlet sessions includes receiving, at a web-based application server, a content request from an external application, and in response to receiving the content request, instantiating a portlet session between the web-based application server and the external application. The method also includes instantiating a reverse proxy session between the external application and a reverse proxy server, wherein the reverse proxy session is associated with the portlet session. The method includes retrieving a response to the content request using the reverse proxy session and transmitting the response to the external application using the reverse proxy session.

### BACKGROUND

The present disclosure relates to allowing a reverse proxy server running in a web application server to delegate its session to its instantiating portlet session running in the same web application server.

Conventional web application servers do not provide easy methods for sliming information between sessions. This is especially true for sharing information between portlet and non-portlet sessions. Typically, an external user interface runs on a dedicated server, not in a web application server. Thus, there is a need to ‘slice and dice’ information from the external user interface so only a subset of information that the user should have access to appears in the external user interface.

### SUMMARY OF THE INVENTION

According to an aspect of the present disclosure, a method includes receiving, at a web-based application server, a content request from an external application, and in response to receiving the content request, instantiating a portlet session between the web-based application server and the external application. The method also includes instantiating a reverse proxy session between the external application and a reverse proxy server, wherein the reverse proxy session is associated with the portlet session in the web-based application server. The method includes retrieving a response to the content request using the reverse proxy session and transmitting the response to the external application using the reverse proxy session.

According to another aspect of the present disclosure, a non-transitory computer-readable storage medium, comprising computer-executable instructions stored on the computer-readable storage medium, the instructions executable to perform: receiving a request from an external application at a portal server and instantiating a portlet session between the external application and the portal server. In response to instantiating the portlet session the instructions are also executable to perform, instantiating a reverse proxy session between the external application and a reverse proxy server, wherein the reverse proxy session is associated with the portlet session in the portal server. The instructions are also executable to perform retrieving requested information from the portal server or additional servers using the reverse proxy session and sending the retrieved information to the external application using the portlet session.

According to an aspect of the present disclosure, a system includes a portal server of a web-based application and a reverse proxy server running on the web-based application. The portal server is configured to: receive a request for content from an external application and instantiate a portlet session between the external application and the portal. The portal server is also configured to instantiate a shadow session between the external application and the reverse proxy server, wherein the shadow session is associated with the portlet session in the web-based application. The portal server is configured to retrieve the requested information from the portal server or an additional server and return the requested information to the external application.

Other objects, features, and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements.

FIG. 1 illustrates a high-level block diagram of a system for delegating a reverse proxy session to its instantiating portlet session, in accordance with a particular embodiment of the present disclosure.

FIG. 2 illustrates a high-level block diagram of a system for delegating a reverse proxy session to its instantiating portlet session, in accordance with a particular embodiment of the present disclosure.

FIG. 3 illustrates a flow chart of a method for authenticating an external application requesting to access information through a reverse proxy session and its instantiating portlet session, in accordance with a particular embodiment of the present disclosure.

FIG. 4 illustrates a flow chart of a method for authenticating an external application requesting to access information through a reverse proxy session and its instantiating portlet session, in accordance with a particular embodiment of the present disclosure.

FIG. 5 illustrates a high-level block diagram of a system for delegating a reverse proxy session to its instantiating portlet session where requests from multiple external applications are received at the same web application server, in accordance with a particular embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not listed to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may he made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to infrastructure management, systems and methods disclosed herein may be related to other areas beyond network infrastructure. Systems and methods disclosed herein may be related to, and used by, any predictive system that utilizes expert learning or other predictive methods. Systems and methods disclosed herein may be applicable to broad range of applications that, such as, for example, research activities (e.g., research and design, development, collaboration), commercial activities (e.g., sales, advertising, financial evaluation and modeling, inventory control, asset logistics and scheduling), IT systems (e.g., computing systems, cloud computing, network access, security, service provisioning), medicine (e.g., diagnosis or prediction within a particular specialty or sub-specialty), and other activities of importance to a user or organization.

In accordance with the teachings of the present disclosure, systems and methods are provided to allow a web application server to encapsulate the features and functionality of an external application, while gating access to the web application server through authenticated portlet sessions running in the same web application server, with a reverse proxy session associated with the session of the portlet which caused it to be instantiated.

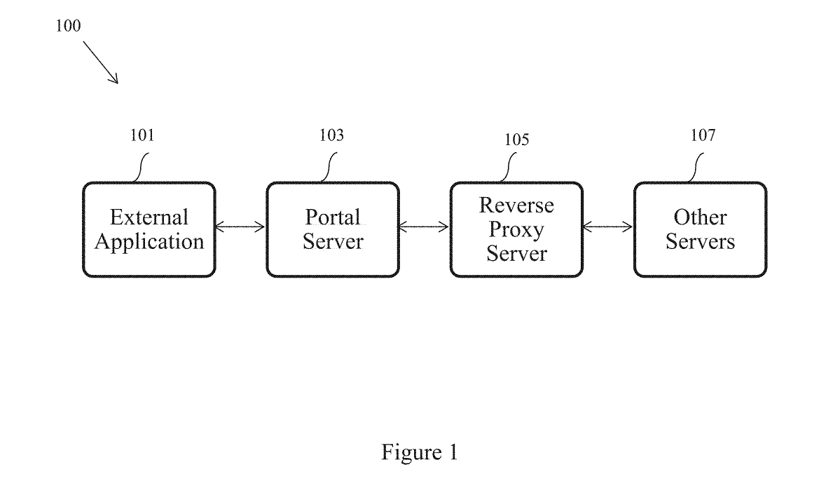

Referring now to FIG. 1, a high-level block diagram of a system 100 according to an embodiment is depicted. An external application 101 may request content from a portal server 103. A user of the external application 101 may request content from the portal server 103 through any suitable external user interface, including but not limited to an Internet browser (not shown). The portal server 103 is an example embodiment and may be any suitable web application server, including but not limited to Tomcat. A portlet session is instantiated between the external application 101 and the portal server 103 upon receiving the content request. The existence of the external application 101 may be captured in the portlet session. The portal server 103 may be associated with a reverse proxy server 105, which may be running in a portion of the portal server 103.

Upon instantiating the external application 101 in the portal server 103, a shadow session may begin between the external application 101 and the reverse proxy server 105. This shadow session may have a 1:1 relationship with the external application's portlet session with the portal server 103. Between the external application 101 and the portal server 103, there may be the original portlet session running between the external application 101 and the portal server 103 running code that handles the portal. There may also be a second, shadow session running between the external application 101 and the reverse proxy server 105 that is paired with the original session that the shadow session was instantiated in response to. This second, shadow session may be created in code running in a portion of the code where the proxy is. Thus, there may be a session in the portal for the main web application and a session running in proxy code.

The requested content may then be retrieved by the reverse proxy server 105 over the shadow session. The reverse proxy server 105 may retrieve the requested content from the portal serve 103 or other servers 107. The retrieved content may be transmitted to the external application's interface, such as a browser, through the reverse proxy session. Therefore, it may appear to a user of the external application 101 that there is only one interface that seamlessly returns requested content. In the portal server 103, the portal server 103 is authenticating and authorizing each request to ensure only appropriate information is returned to the external application 101. This may allow a web application server to encapsulate the features and functionality of the external application, while gating access to it through the authenticated shadow sessions associated with portlet sessions. The portlet session has a session identifier associated with it. The web application server may receive user credentials from the external application 101 and those may be associated with the session identifier. The request can be authenticated and authorized based on the user credentials associated with the portlet session, verifying whether the user credentials match the session identifier, and whether the user credentials indicate the external application has permission to access the requested content. The end of each session may be configurable to end based on an idle time of the user or a user may log out to end the session.

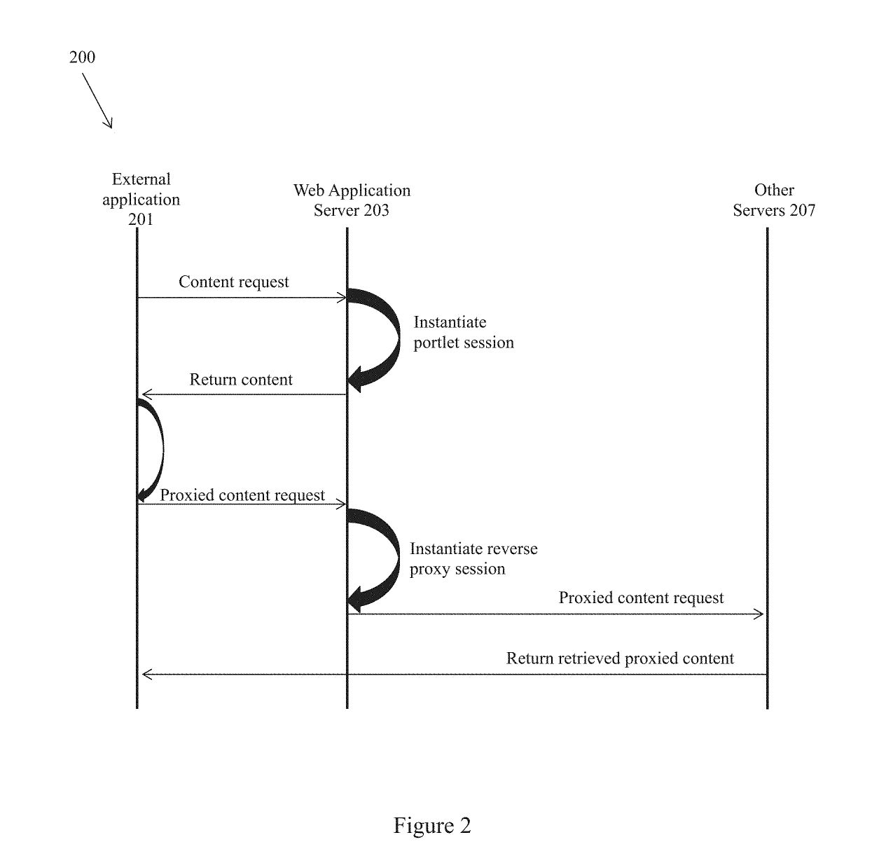

Referring now to FIG. 2, a high-level block diagram of a system 200 according to an embodiment is depicted. A user of an external application 201 may request content through any suitable external user interface, including but not limited to an Internet browser (not shown). This content request may be received by a web application server 203. The web application server 203 may instantiate a portlet session between the web application server 203 and the external application 201 and return some content to the external application 201, such as a browser. The web application server 203 may receive a request for proxied content. In response to the request for proxied content, a reverse proxy session may be instantiated between the external application 201 and a reverse proxy server (not shown). The reverse proxy server may be running in a portion of the code of web application server 203. The reverse proxy session may retrieve information responsive to the proxied content request from other servers 207 or the web application server 203. The retrieved information may be transmitted to the external application 201. The portlet session may authenticate and authorize content requests received from the external application 201, such that the reverse proxy session is only used to retrieve information responsive to authenticated and authorized requests. The reverse proxy session may be associated with the portlet session and run between the external application 201 and the reverse proxy server. When the external application 201 enters the web application server 203 by making a request for content, the external application 201 may get an identity and the association of the reverse proxy session may be verified against the original identity.

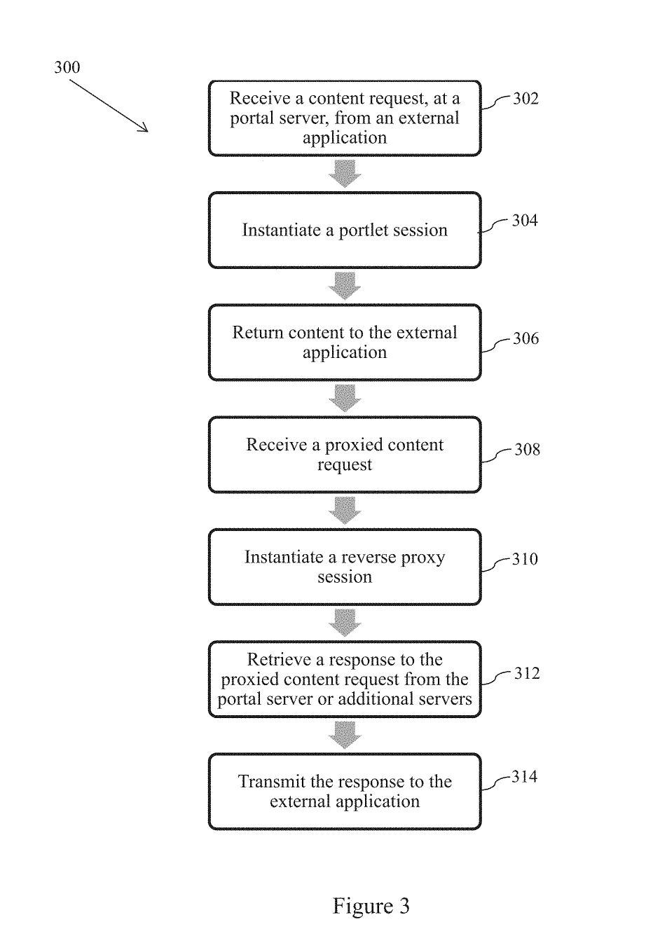

Referring now to FIG. 3, a flow chart of a method 300 according to an embodiment is depicted. At step 302, a request for content is received at a portal server from an external application. In response to the request, at step 304, a portlet session may be instantiated. At step 306, the web application server sends a small amount of content back to the external application, such as a browser, which then sends a request for proxied content at step 308. In response to the instantiation of the portlet session between the external application and the portal server and receipt of the proxied content request, a reverse proxy session is instantiated between the external application and a reverse proxy server at step 310. The reverse proxy session is associated with the portlet session in the portal server and at step 312, a response to the proxied content request is retrieved over the reverse proxy session from the portal server or from additional servers. At step 314, the retrieved proxied content response is transmitted to the external application.

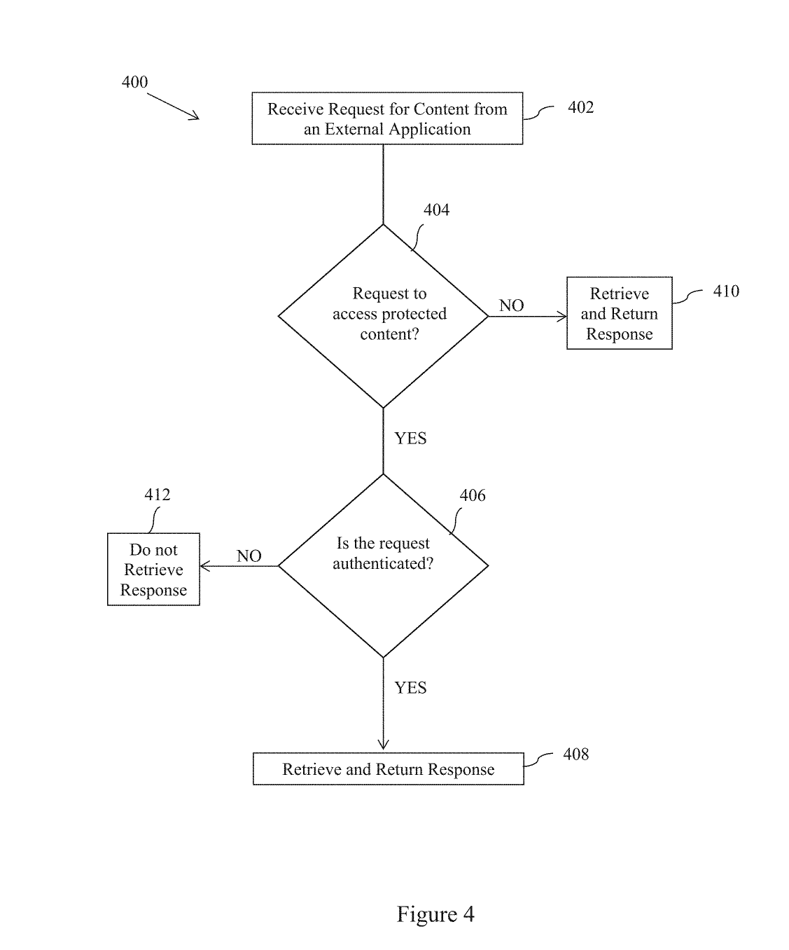

Referring now to FIG. 4, a flow chart of a method 400 according to an embodiment is depicted. At step 402, a web application server, such as the portal server 103 depicted in FIG. 1, receives a request for content from an external application, such as the external application 101 depicted in FIG. 1. At step 404, the server determines whether the request is directed to accessing protected content. If the request is for protected content, the server determines whether the request is authenticated and authorized at step 406. If the request is authenticated, at step 408, the content is retrieved in response to the request using a reverse proxy session associated with a portlet session and returned to the external application. The portlet session may function as a security barrier and filter by authenticating and checking an authorization of the external application.

If the server determines that the request is not to access protected content at step 404, the server proceeds to step 410, and the reverse proxy session retrieves content in response to the request and the retrieved content is returned to the external application. If the server determines that the request is not authenticated or authorized at step 406, then the reverse proxy session does not retrieve any of the protected content in response to the request at step 412. If a user is not supposed to have access to content the user is trying to access on a user interface of an external application, the reverse proxy server will not retrieve that content and will not return that content to the user.

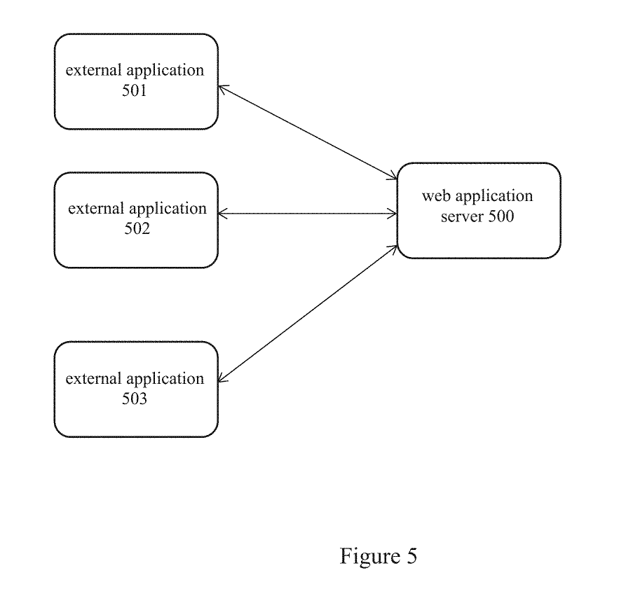

Referring to FIG. 5, a web application server 500, such as portal server 10′3 or web application server 203, may support multitenancy and receive requests from a plurality of external applications, such as external applications 501, 502, and 503. The web application server 500 encapsulates the features and functionality of each external application 501, 502, and 503, while gating access to the web application server 500 through authenticated portlet sessions. The portlet sessions authenticate and authorize tasks for a reverse proxy session, which the portlet session causes to be instantiated. Each external application 501, 502, and 503 may have an individual session with the web application server 500 and an individual shadow session with a reverse proxy server 505. Each reverse proxy session is associated with the session of the portlet which caused it to be instantiated in the web application server. The reverse proxy session enables retrieving information from the web application server or other additional servers on the same network, and returning the information through the initial portlet session. The individual portlet session between each external application 501, 502, and 503 and the web application server 500 carries out authenticating and authorizing tasks for the specific external application Each portlet session has a unique session identifier associated with it. The web application server 500 may receive user credentials from the external applications 501, 502, and 503, and those credentials may be associated with the unique session identifier. The request from each external application 501, 502, and 503 can be authenticated and authorized based on the user credentials associated with the portlet session of the particular external application, verifying whether the user credentials snatch the session identifier, and whether the user credentials indicate the external application has permission to access the requested content. The authenticating portlet sessions may find that external applications 501 and 502 are authenticated and authorized to access the requested content and may return a response containing the requested content. On the other hand, the authenticating portlet session may find that external application 503 is not authenticated or authorized to access the requested information and will not return a response containing the content to the external application 503.

The flowchart and block diagrams in the figures illustrate the architecture functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terns “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
receiving, at a web-based application server, a content request from an external application;
in response to receiving the content request, instantiating a portlet session between the web-based application server and the external application;
instantiating a reverse proxy session between the external application and a reverse proxy server, wherein the reverse proxy session is associated with the portlet session in the web-based application server;
retrieving a response to the content request using the reverse proxy session; and
transmitting the response to the external application using the reverse proxy session.

2. The method of claim 1, wherein the web-based application server comprises a portal server.

3. The method of claim 1, further comprising:
authenticating and authorizing the content request using the portlet session, and
wherein the reverse proxy session is instantiated in response to authenticating and authorizing the content request.

4. The method of claim 3, wherein authenticating and authorizing the content request comprises:
associating a session identifier with the portlet session;
receiving user credentials associated with the session identifier; and
authenticating the content request in response to the user credentials.

5. The method of claim 4, wherein authenticating the content request in response to the user credentials comprises:
verifying that the user credentials match the session identifier.

6. The method of claim 1, wherein retrieving a response to the content request using the reverse proxy session further comprises:
retrieving data stored on an additional server.

7. The method of claim 1, further comprising:
receiving, at the web-based application server, a second content request from a second external application; and
in response to the second content request, instantiating a second portlet session between the web-based application server and the second external application, wherein the second portlet session is associated with a second session identifier,
wherein the second content request is different than the content request.

8. The method of claim 7, further comprising:
instantiating a second reverse proxy session between the second external application and the reverse proxy server, wherein the second reverse proxy session is associated with the second portlet session in the web-based application server;
authenticating and authorizing the second content request using the second portlet session;
in response to authenticating and authorizing the second content request, retrieving a second response from the additional server using the reverse proxy server; and
transmitting the second response to the second external application.

9. The method of claim 7, further comprising:
instantiating a second reverse proxy session between the second external application and the reverse proxy server, wherein the second reverse proxy session is associated with the second portlet session in the web-based application server;
authenticating and authorizing the second content request using the second portlet session; and
in response to determining the second content request is not authenticated or authorized, not retrieving a second response using the second reverse proxy session.

10. The method of claim 1, wherein receiving, at a web-based application server, a content request from an external application comprises receiving a request for proxied content

11. The method of claim 1, further comprising:
in response to receiving a logout indication from the external application, ending the portlet session.

12. A non-transitory computer-readable storage medium, comprising computer-executable instructions stored on the computer-readable storage medium, the instructions executable to perform:
receiving a request from an external application at a portal server;
instantiating a portlet session between the external application and the portal server;
in response to instantiating the portlet session, instantiating a reverse proxy session between the external application and a reverse proxy server, wherein the reverse proxy session is associated with the portlet session in the portal server;
retrieving requested information from the portal server or additional servers using the reverse proxy session; and
sending the retrieved information to the external application using the reverse proxy session.

13. The non-transitory computer-readable storage medium of claim 12, wherein the instructions are executable to perform:
authenticating the request to determine whether the request is soliciting appropriate information; and
in response to determining the request is soliciting appropriate information retrieving request information using the reverse proxy session.

14. The non-transitory computer-readable storage medium of claim 12, wherein the instructions are executable to perform:
checking an authorization of the request to determine whether the request is seeking information that the external application has permission to access; and
in response to determining that the external application is not supposed to have access to the requested information, not retrieving the requested information.

15. The non-transitory computer-readable storage medium of claim 12, wherein the instructions are executable to perform:
in response to receiving an idle indication from the external application, ending the portlet session.

16. A system, comprising:
a portal server of a web-based application; and
a reverse proxy server running on the web-based application,
wherein the portal server is configured to:
receive a request for content from an external application;
instantiate a portlet session between the external application and the portal server;
instantiate a shadow session between the external application and the reverse proxy server, wherein the shadow session is associated with the portlet session in the portal server;
retrieve the requested information from the portal server or an additional server; and
return the requested information to the external application.

17. The system of claim 16, wherein the shadow session is instantiated in response to authenticating and authorizing the request.

18. The system of claim 16, where the portal server is configured to receive a plurality of requests from a plurality of external applications.

19. The system of claim 18, wherein the plurality of external applications comprises a first external application and a second external application, and the plurality of requests comprises a first request from the first external application and a second request from the second external application.

20. The system of claim 19, wherein the portal server is further configured to:
instantiate a first portlet session in response to receiving the first request;
authenticates and checks authorization of the first request;
in response to determining the first request is authenticated and authorized, instantiate a first shadow session between the first external application and the reverse proxy server;
instantiate a second portlet session in response to receiving the second request;
authenticate and check authorization of the second request; and
in response to determining the second request is not authenticated or unauthorized, not retrieve the requested information.
